(19) United States
(12) Patent Application Publication
(10) Pub. No.: US 2002/0170341 A1
(43) Pub. Date: Nov. 21, 2002

(54) Measuring system for a viscosity measurement of liquids

(76) Inventors: Bernhard Jakoby, Wien (AT); Kurt Weiblen, Metzingen (DE); Volker Brielmann, Ludwigsburg (DE)

Correspondence Address: KENYON & KENYON, ONE BROADWAY, NEW YORK, NY, 10004, US

(21) Appl. No.: 10/098,650

(22) Filed: Mar. 15, 2002

(30) Foreign Application Priority Data
Mar. 15, 2001 (DE) 101 12 433.3-52

(51) Int. Cl. G01N 11/10; G01N 11/16

(52) U.S. Cl. 73/54.24; 73/54.41

(57) ABSTRACT

A system for measuring the properties of liquids, in particular, for measuring the viscosity of a liquid, includes a piezoelectric sensor device, which is completely immersed in liquid and has electric contact points for an electric control which are resistant with regard to the liquid. The piezoelectric sensor device includes electric lead conductors, which are resistant with regard to the liquid and are connectable to an electronic control/analyzer unit outside of liquid and to contact points within the sensor device by a suitable conductive adhesive containing metal particles.

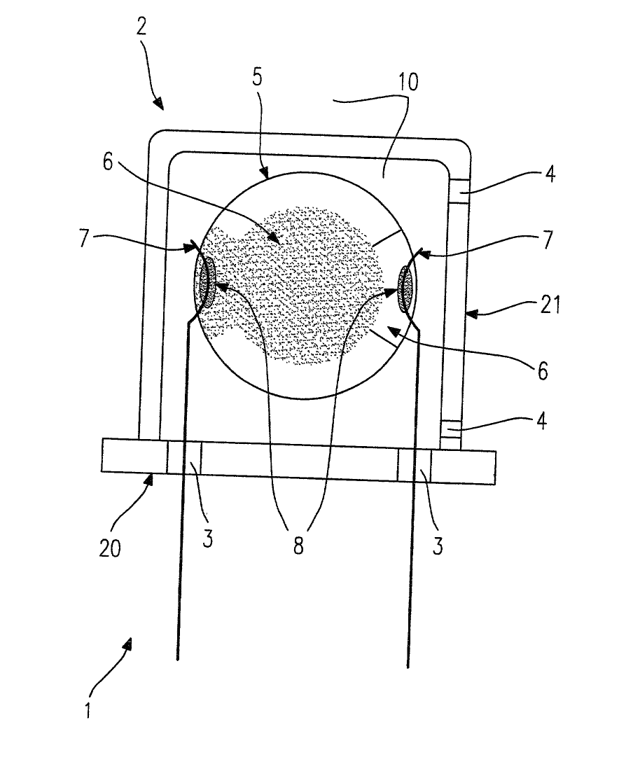

### FIELD OF THE INVENTION

The present invention relates to a measuring system for measuring the properties of liquids, in particular for measuring the viscosity of a liquid. A piezoelectric sensor device is provided in the liquid to be measured, and is electrically controlled and analyzed.

### BACKGROUND INFORMATION

Piezoelectric thickness shear vibrators made of quartz, for example, have been used for viscosity measurements for some time. See, for example, S. M. Martin et al., Sens. Act. A 44 (1994) pages 209-218. When such a thickness shear vibrator is immersed in a viscous liquid, the resonant frequency of the natural vibration and its attenuation vary as a function of the viscosity and density of the viscous liquid. Since the density of typical liquids varies to a much greater extent than their viscosity, such a component is virtually a viscosity sensor.

In the past, when such viscosity sensors were used in aggressive or corrosive liquids, such as motor oil or transmission oil, the surfaces of the component to be wetted were usually brought in contact with the liquid through sealing devices, such as 0 rings or the like.

One disadvantage of this known approach is the fact that in attaching such sealing devices, a mechanical pressure is applied to the part to guarantee a seal. However, this results in an undesirable influence on the electric properties of the part and thus to an inaccurate measurement analysis.

### SUMMARY OF THE INVENTION

According to the present invention, a piezoelectric sensor device is immersed completely in the liquid to be measured in the container and has electric contact points for an electric control, the contact points being resistant with regard to the liquid. Inside the container, electric leads are provided which are resistant with regard to the liquid and are connectable to an electronic control/analyzer unit outside the container and to the contact points of the sensor device by a suitable conductive adhesive containing metal particles.

The measuring system according to the present invention has the advantage that there is no influence on the electric properties of the piezoelectric sensor device during the measuring operation due to mechanical impact, and thus an accurate measurement of the viscosity of the liquid may be performed. In addition, selecting suitable contact and lead wire materials and a suitable conductive adhesive guarantees complete immersion of the sensor device in the liquid to be measured. This further increases the measuring accuracy.

According to a particular refinement, the piezoelectric sensor device is designed as a disk-shaped quartz crystal and is excitable to shearing oscillations by an electric control.

However, other piezoelectric materials such as lithium tantalate piezoceramics or the like may also be used.

According to another refinement, the liquid to be measured is an oil. For use in oil in particular, the contact points may be designed as gold or chromium electrodes and the lead conductors may be designed as gold-plated or chromium-plated wires. These are extremely medium-resistant materials with respect to oil.

According to another refinement, the electric lead conductors are designed as bifurcated contact springs. Accommodation of a disk-shaped sensor device by the contact springs is facilitated by such a bifurcated shape.

According to another refinement, the sensor device is in a protective container having a bottom and a cap which may also be introduced into the liquid. In this case, the container provides mechanical protection for the measuring system.

According to another refinement, the electric lead conductors are led out of the container through bushings, in particular glass bushings, in the container cap and/or the container bottom. Thus the sensor device is activated via external electronics.

According to another refinement, the electric lead conductors are connectable to connecting leads in the container cap and/or container bottom. The lead conductors are connected to connecting wires in the container cap and/or container bottom by suitable joining methods such as welding. This also ensures an electric connection to an external voltage source.

According to another refinement, at least one opening is provided in the container for a liquid inlet/outlet.

According to another refinement, the container is hermetically sealable.

According to another refinement, the conductive adhesive is an isotropic, electrically conductive adhesive based on an epoxy resin, a phenolic resin or a polyimide, in particular based on an epoxy-phenolic resin. This guarantees a good electric and mechanical contact of the sensor device with the corresponding lead conductors.

According to another refinement, the metal particles in the conductive adhesive are nickel or gold particles, which may have a particle size of approximately 2 μm to 20 μm.

According to another refinement, nickel or gold particles are present in the conductive adhesive in a concentration of 75 to 95 wt %.

### BRIEF DESCRIPTION OF THE DRAWING

The FIGURE shows a cross section through a measuring system according to one embodiment of the present invention.

### DETAILED DESCRIPTION

The FIGURE illustrates a cross section through a measuring system 1 according to one embodiment of the present invention.

A container 2 is designed in two parts according to the present invention, including a bottom 20 and a cap 21 detachably mounted thereon, and it is immersed completely in liquid 10 to be measured. Cap 21 has openings 4 for a liquid exchange situated on the side and/or at the top, the opening closer to the top may function as a liquid inlet, and the opening situated closer to the bottom may function as a liquid outlet. Bottom 20 of the container 2 has two glass bushings 3.

As described above, the entire measuring system 1 is situated in a liquid 10 whose viscosity or other liquid properties are to be measured. The entire container 2 is thus also filled with liquid 10 through openings 4.

According to an exemplary embodiment, oil is used as liquid 10, however, other liquids in combination with suitable materials can also be measured.

A sensor device 5, which may be a piezoelectric quartz crystal, for example, has a disk-shaped design and is completely immersed in liquid 10 in container 2. Disk-shaped quartz sensor 5 has two electric contact points 6 which are designed as gold or chromium electrodes 6 according to the present embodiment. For a specific use in oil, e.g., motor oil or transmission oil, gold or chromium electrodes have proven to be especially robust materials.

Contact points 6 are connected by a suitable conductive adhesive 8 to electric lead conductors 7 which are designed as gold-plated or chromium-plated wires according to the present embodiment. These gold-plated or chromium-plated wires have proven to be especially robust materials for a specific use in oil. Electric lead conductors 7 may also be designed as bifurcated contact springs 7 for mechanical accommodation of the piezoelectric quartz disk 5.

Conductive adhesive 8 guarantees the electric and mechanical contact of the piezoelectric quartz disk 5 with contact springs 7 at contact points 6. According to the present embodiment, isotropic, electrically conductive adhesive 8 advantageously is an epoxy resin, a phenolic resin and/or a polyimide. The material of conductive adhesive 8 can also be based on an epoxy-phenol. Isotropic conductive adhesives 8 are provided with metal particles, such as nickel and/or gold particles, in the form of flakes or beads or mixtures thereof. The nickel and/or gold particles may have a particle size of approx. 2 μm to 20 μm. The concentration of the nickel and/or gold particles in conductive adhesive 8 amounts to approx. 75 to 95 wt %.

Electric lead conductors 7 may either pass directly through bottom 20 of container 2 through glass bushings 3 or be connected to corresponding connecting wires in bottom 20 of container 2 by suitable joining methods, e.g., welding. The deciding factor is that an electric connection of sensor device 5 to an electronic control and analyzer unit outside of container 2 for electric control of sensor device 5 and subsequent analysis of the results is established via contact points 6 and electric lead conductors 7, contact points 6, conductive adhesives 8 and electric lead conductors 7 being resistant with regard to liquid 10 to be measured.

Although the present invention has been described above on the basis of an exemplary embodiment, it is not limited to this embodiment, but instead it may be modified in a variety of ways.

Thus, liquids other than oil may be measured, using contact materials and conductive adhesives containing suitable metal particles and electric lead conductor materials that are resistant to this liquid.

In addition, a hermetic seal of the container may be established without any negative effect on the electric connection of the sensor device to the external electronic control/analyzer unit.

What is claimed is:

1. A system for measuring a property of a liquid, comprising:
a piezoelectric sensor device which is completely immersed in the liquid to be measured, the sensor including:
electric contact points for an electric control and which are resistant to the liquid;
electric lead conductors which are resistant to the liquid and which are connectable to an electronic control/analyzer unit arranged outside the liquid; and
a suitable conductive adhesive containing metal particles and for coupling the electric lead conductors to the electric contact points.

2. The system of claim 1, wherein viscosity is the property of the liquid that is measured.

3. The system of claim 1, wherein the piezoelectric sensor device is configured as a disk-shaped quartz crystal and is excitable to shearing oscillations by the electric control.

4. The system of claim 1, wherein the liquid to be measured is an oil.

5. The system of claim 1, wherein the electric contact points are one of gold and chromium electrodes.

6. The system of claim 1, wherein the electric lead conductors are one of gold-plated wires and chromium-plated wires.

7. The system of claim 1, wherein the electric lead conductors are configured as bifurcated contact springs.

8. The system of claim 1, further comprising:
a protective container having a bottom and a cap, the protective container enclosing the piezoelectric sensor device and being able to be introduced into the liquid.

9. The system of claim 8, further comprising:
bushings situated in at least one of the cap and the bottom of the protective container,
wherein the electric lead conductors are led through the protective container through the bushings.

10. The system of claim 9, wherein the bushings are made of glass.

11. The system of claim 8, further comprising:
connecting leads in at least one of the cap and the bottom of the protective container,
wherein the electric lead conductors are connectable to the connecting leads.

12. The system of claim 8, wherein the protective container includes at least one opening for a liquid inlet/outlet.

13. The system of claim 12, wherein the at least one opening is situated in the cap of the protective container.

14. The system of claim 8, wherein the protective container is hermetically sealable.

15. The system of claim 1, wherein the conductive adhesive is an isotropic, electrically conductive adhesive including at least one of an epoxy resin, a phenolic resin, and a polyimide.

16. The system of claim 1, wherein the conductive adhesive is an isotropic, electrically conductive adhesive including an epoxy-phenol.

17. The system of claim 1, wherein the metal particles in the conductive adhesive are at least one of nickel particles and gold particles.

18. The system of claim 17, wherein the at least one of nickel particles and gold particles have a particle size of approximately 2 μm to 20 μm.

19. The system according to claims 17, wherein the at least one of nickel particles and gold particles are provided in the conductive adhesive in a concentration of 75 to 95 wt %.
